(19) United States
(12) Patent Application Publication
(10) Pub. No.: US 2009/0279982 A1
(43) Pub. Date: Nov. 12, 2009

(54) Fastener Assembly and Method

(76) Inventor: Hugues Philippin, Saint-Augustin-de-Desmaures (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/115,831

(22) Filed: May 6, 2008

(51) Int. Cl. F16B 19/00

(52) U.S. Cl. 411/360

(57) ABSTRACT

A fastener assembly allowing two opposed structures to be joined while providing a blind joint is disclosed as well as the method to join these two opposed structures. The fastener assembly comprises a double-ended male part and a female part. The male part has a first end generally adapted to be fixed into one of the two structures and a second end extending therefrom. The female part is generally adapted to be fixed into the other one of the two structures and further comprises a passage way adapted to receive the second end of the male part in a locking yet releasable arrangement.

### CROSS-REFERENCE TO RELATED APPLICATIONS

The present patent application claims the benefits of priority of commonly assigned Canadian Patent Application (patent application number to come), entitled “Fastener Assembly and Method” and filed at the Canadian Intellectual Property Office on Apr. 7, 2008.

### FIELD OF THE INVENTION

The present invention generally relates to fasteners, and more particularly to concealed fasteners allowing two opposed structures to be joined and a method using such fasteners.

### BACKGROUND OF THE INVENTION

This invention relates to fasteners for joining a pair of panels or other similar structural elements. Sometimes it is necessary or preferable to produce blind joints. A blind joint is a joint where, after the joint has been assembled, the joint itself becomes invisible to observers. These joints are preferred over other types of joints because they hide the appearance of the actual joint itself.

Mechanical fasteners, such as nails and screws, can also be used to create joints. Mechanical fasteners are generally much easier to use (they require little or no skill), and can be used to produce joints quickly. However, mechanical fasteners by themselves cannot be used to create blind joints. On some pieces, for example, high-quality furniture and trimwork, the appearance of exposed mechanical fasteners such as nails and screws is not desired. Furthermore, it is often necessary to hide there joints forever.

Blind joints currently exist, but prior art blind joints require expensive tools, jigs, or fixtures, and are usually difficult to make. Some examples of existing blind joints include the mortise-and-tenon joint, half-blind dovetail joint, double-blind dovetail, a dowel joint and a biscuit joint. Although well known in the prior art, these joints require either considerable machining and skill, in the case of the mortise-and-tenon joint, half-blind dovetail joint, and the double-blind dovetail, or expensive jigs and fixtures and specialized tools, in the case of the dowel joint and the biscuit joint.

In addition to the specialized tools, considerable skill is also required to properly make such joints. They also require a considerable amount of time to lay out and prepare the various tools to make the appropriate cuts for these joints.

### OBJECTS OF THE INVENTION

A first object of the present invention is to provide a fastener assembly to join two structures together.

A second object of the present invention is to provide a fastener assembly which joins two structures in a concealed manner.

A third object of the present invention is to provide a concealed fastener assembly which is simple to use and that does not need further steps to conceal the fastener assembly after the junction of its parts.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

The aforesaid and other objectives of the present invention are realized by generally providing a fastener assembly allowing to join a first structure to a second structure in a concealed manner, the fastener assembly comprising a female part adapted to be fixed to the second structure, the second structure comprising a passage way having a first end and a second end, a male part, the male part comprising a first end and a second end, the male part being adapted to be fixed to the first structure through first end of the male part, the second end of the male part being adapted to be received by the passage way, the second end of the male part comprising a groove, and a locking ring comprising, the locking ring comprising an opening and the locking ring being adapted to be received by the groove of the male part.

The fastener assembly of the present invention allows two structures to be joined together in a concealed manner. In the case of wall panels, this means that the visible surface of the panels does not have to be pierced by nails or screws. Therefore, it is not necessary to fill holes or cracks with gypsum plaster, plastic wood or other similar products usually used to fill the resulting holes in the panel.

The fastener assembly is of very simple use and installation. The male part is inserted in the first structure and the female part in the second structure. The male part is then simply aligned with the passage way of the female part and pushed into it. The second end of the male part and the first end of the female part comprise means to fix them into their respective structures. The male and the female part are preferably screwed into the structures.

The fastener assembly comprises compressible locking means to secure the connection between the female part and the male part. The compressible locking means is compressed and then inserted into the passage way of the female part. The compressible locking means is typically a locking ring, the locking ring having a substantially circular shape and comprising an opening. The compressible locking ring expands when exiting the passage way at the second end of the female part.

The fastener assembly of the present invention may be releasable or not. Indeed, if the second end of the female part is tapered, this prevents the locking ring to be compressed into the groove of the male part thus creating a resistance to the removal of the male part from the female part. To remove the male part from the female part, it would be necessary to apply a force which is sufficient to brake or disengage the locking ring.

The fastener assembly may be releasable if the first structure has to be removed for any reason. In this case, the second end of the female part is countersunk allowing the locking ring to be compressed again into the groove when the male part is pulled from the female part, allowing the male part to be removed from the female part.

The structures are typically walls, vertical panels, studs or other structures on which the female part and/or the male part can be fixed. In the present document, these structures are referred to as the first and the second structure. The first structure being the one on which the male part is fixed and the second structure the one on which the female portion is fixed.

When assembled, the first and the second structures may be in contact together or their may be a gap between them. The male part comprises a flange between its first and second end and this flange may be inserted or not in the first structure. When the flange is inserted in the first structure, into a recess practiced for this purpose, the structures may be in contact together. Inversely, if the flange abuts against the first structure, a gap will be present between both structures corresponding to at least of the thickness of the flange.

The material used for the fastener assembly may be selected according to its use. For example, in cases of small loads, the fastener assembly may be made of plastic. In cases of heavier loads, the fastener assembly may be made of metal and/or metal alloys. The number of fastener assemblies depends on the load and the shape of the structures to be fixed together. The material of the locking ring is preferably slightly resilient (for example plastic or metal) allowing it to be compressed without damage.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIGS. 1a and 1b are respectively a top view and a cross-sectional view along A-A of an embodiment of the female part of the fastener assembly.

FIGS. 2a is and 2b are respectively a top view and a cross-sectional view along B-B of another embodiment of the female part of the fastener assembly.

FIGS. 3a is and 3b are respectively a cross-sectional view and a top view of the male part of the fastener assembly.

FIG. 4 is a side view of the locking ring of the fastener assembly.

FIG. 5 is a cross-sectional view of the fastener assembly prior to be assembled.

FIG. 6 is a cross-sectional view of an embodiment of the fastener as assembled.

FIG. 7 is a cross-sectional view of another embodiment the fastener assembly as assembled.

FIG. 8 is a cross-sectional view of a further embodiment of the fastener assembly which is releasable.

FIGS. 9a and 9b are cross-sectional view showing two different ways to fix the male part to the first structure.

### DETAILED DESCRIPTION OF THE PREFERRED EMBODIMENT

A novel fastener assembly will be described hereinafter. Although the invention is described in terms of specific illustrative embodiment(s), it is to be understood that the embodiment(s) described herein are by way of example only and that the scope of the invention is not intended to be limited thereby.

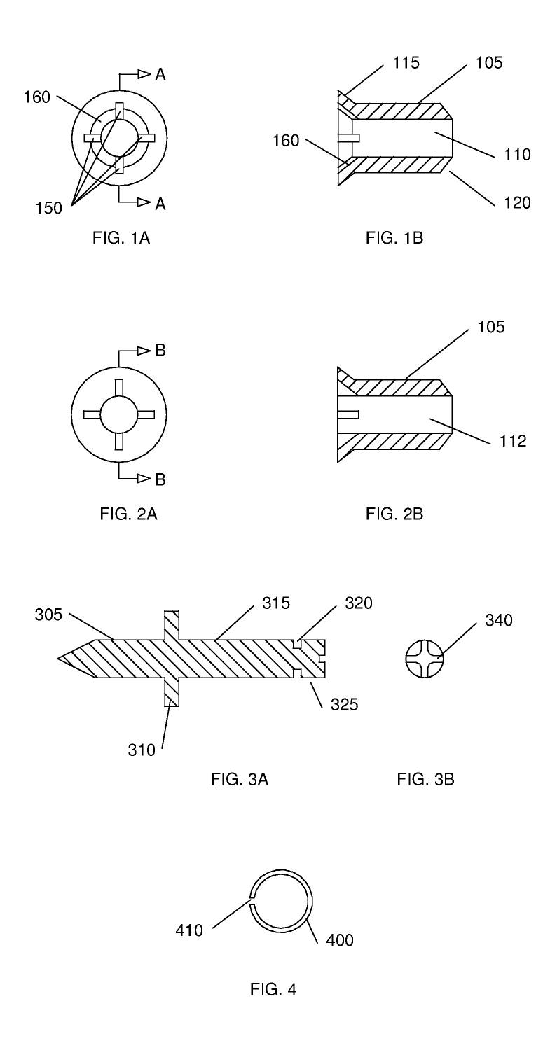

FIGS. 1a and 1b show the female part of the fastener assembly. The external surface 105 is preferably threaded to be fixed on the second structure (not shown). The passage way 110 is adapted to receive the male part (shown in FIG. 3a). The first end 115 of the female part is adapted to receive a screwdriver, as shown by the slots 150, allowing the female part to be screwed in the second structure. In the embodiment of FIGS. 1a and 1b, the passage way 110 is preferably countersunk at the first end 115 of the female part, creating a diagonal surface 160, to facilitate the insertion of the male part and the locking ring (shown in FIG. 4) in the female part. In this embodiment, the second end of the female part is tapered 120.

FIGS. 2a and 2b show another embodiment of the female part wherein the passage way 112 has the same diameter everywhere instead of being countersunk at the first end as seen in FIGS. 1a and 1b. When the male part (not shown in this picture) is inserted into the female part, the ring is forced to fit into the groove so the male part may be inserted into the passage way.

FIG. 3a shows the male part of the fastener assembly which is adapted to be inserted in the female part. The male part is double-ended, the first end 305 being adapted to be fixed to the first structure (not shown) and the second end 325 adapted to be received by the female part of the fastener assembly. The male part is preferably screwed in the first structure and the first end 305 is threaded for this purpose. The flange 310, located between the first end and the second end of the male part, abuts against the first structure. A groove 320 is located near the second end 325 of the male part which is adapted to receive the locking ring (FIG. 4). The second end 325 is adapted to receive a screwdriver, as shown by the slot 340, allowing the male part to be screwed in the first structure.

It is to be noted that even if in a preferred embodiment, the male part and the female part are threaded so they can be screwed to the first structure and the second structure, it is possible to use other known means to fix them to the first structure and the second structure. For example, the male part and the female part could be press-fitted into the first and the second structure by choosing a hole diameter causing a compression on the male part and the female part, the compression being applied by the structures in which the male and the female part are inserted. Another locking means could be a locking part that is contained in the structures, the male part and the female part being rotated or pushed into locking engagement with the structures.

FIG. 4 shows the locking ring 400 which comprises an opening 410. The opening 410 allows the ring to be compressed when inserted in the passage way of the female part and to re-extend after it has passed the second end 120 of the passage way. The material of the locking ring is preferably slightly resilient allowing it to be compressed without damage. The opening 410 help the locking ring to be compressed and may be longer or shorter depending of the resiliency of the material of the locking ring.

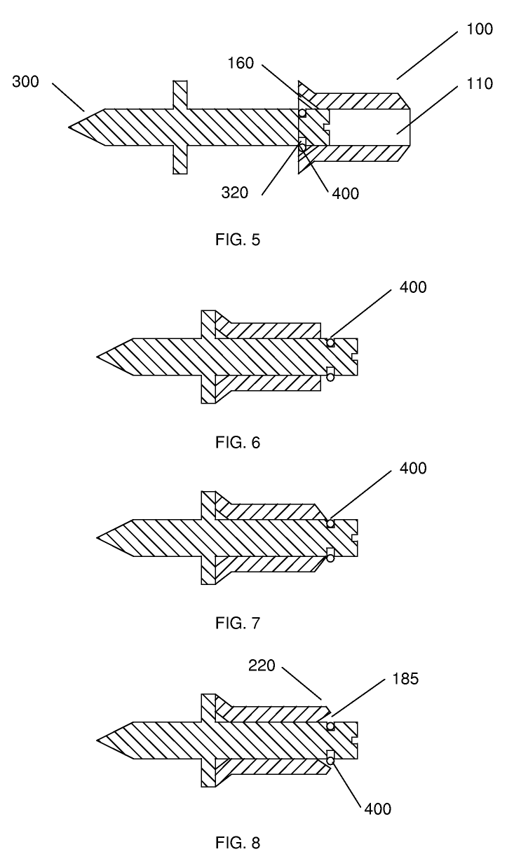

FIG. 5 shows the fastener assembly at the beginning of the assembly process, the male part 300 being partially inserted in the female part 100 with the locking ring 400 inserted in the groove 320 of the male part 300. When the locking ring 400 enters in contact with the diagonal surface 160, it forces the locking ring 400 to compress and to fit into the groove 320 allowing the male part 300 to pass into the passage way 110. When the male part 300 is completely inserted as shown in FIG. 8, the locking ring 400 will expand and maintain the male part 300 in this position, the locking ring restraining it from being removed from the female part 100.

In FIG. 6, the second end of the female part has a right angle profile.

In FIG. 8, a releasable fastener assembly is shown. The second end 220 of the female part 100 is countersunk 185 allowing the locking ring 400 to be compressed into the groove 320 when the male part 300 is pulled out of the passage way 110.

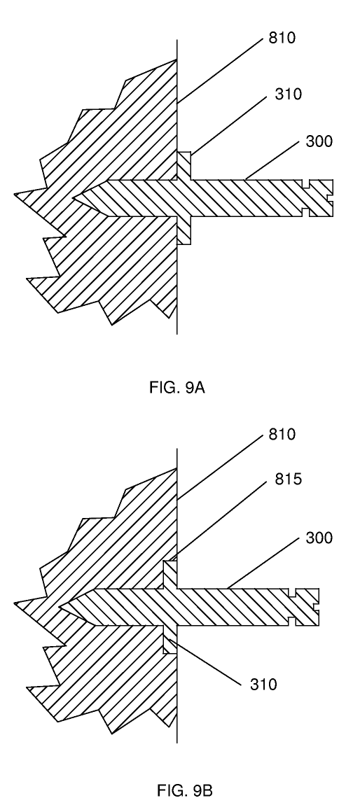

In FIGS. 9a and 9b, two different ways to fix the male part 300 to the first structure 810 are shown. In FIG. 9a, the flange 310 abuts against the first structure 810. In FIG. 9b, the flange is insert into a recess 815 in the first structure. The recess 815 is made prior to the installation and is used when the first structure 810 has to be in contact with the second structure (not shown). If the male part and flange 310 are inserted as shown in FIG. 9a, there will be a gap between both structures, the gap being at least the thickness of the flange 310.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1. A fastener assembly allowing to join a first structure to a second structure in a concealed manner, said fastener assembly comprising:
a) a female part adapted to be fixed to said second structure, said female part comprising a passage way having a first end and a second end;
b) a male part, said male part comprising a first end and a second end, said male part being adapted to be fixed to said first structure through first end of said male part;
c) compressible locking means, said compressible locking means located near said second end of said male part.

2. The fastener assembly of claim 1, wherein said second end of said male part comprises a groove.

3. The fastener assembly of claim 2, wherein said releasable locking means is a locking ring, said locking ring comprising an opening and said locking ring cooperating with said groove of said male part.

4. The fastener assembly of claim 3, wherein said locking ring is compressible.

5. The fastener assembly of claim 1, wherein said male part further comprises a flange between said first end and said second end of said male part.

6. The fastener assembly of claim 1, wherein at least one of said first and second ends of said female part is countersunk.

7. The fastener assembly of claim 1, wherein said both said first and second ends of said female part are countersunk.

8. The fastener assembly of claim 1, wherein said second end of said female part is tapered.

9. The fastener assembly of claim 1, wherein said first end of said male part is threaded.

10. The fastener assembly of claim 1, wherein said female part comprises an external surface, said external surface being threaded.

11. A method to join a first structure to a second structure in a concealed manner using a fastener assembly, said fastener assembly comprising a female part having a first end and a second end and a male part having a first end and a second end, said female part comprising a passage way, said male part comprising a groove adapted to receive a locking ring and said male part being adapted to be received by said passage way, said method comprising the steps of:
a) fixing at least one said female part to said first structure;
b) fixing at least one said male part to said second structure;
c) inserting said male part into said passage way by compressing said locking ring into said groove.

12. The method of claim 11, wherein said first structure is a wall structure.

13. The method of claim 12, wherein said second structure is a panel.

14. A fastener assembly allowing to join a first structure to a second structure in a concealed manner, said fastener assembly comprising:
a) a female part adapted to be fixed to said second structure, said female part comprising a passage way having a first end and a second end;
b) a male part, said male part comprising a first end and a second end, said male part being adapted to be fixed to said first structure through first end of said male part, and said male part comprising a groove near said second end and a flange between said first end and said second end;
c) a locking ring, said locking ring comprising an opening and said locking ring cooperating with said groove, said locking ring being adapted to be compressed into said groove.
